(19) United States
(12) Patent Application Publication
(10) Pub. No.: US 2016/0353160 A1
(43) Pub. Date: Dec. 1, 2016

(54) SMART TERMINAL AS WELL AS FAST CHANNEL SWITCHING METHOD AND DEVICE THEREOF

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Peng HUANG, Tianjin (CN)

(21) Appl. No.: 15/232,737

(22) Filed: Aug. 9, 2016

Related U.S. Application Data
(63) Continuation of application No. PCT/CN2015/088859, filed on Sep. 2, 2015.

(30) Foreign Application Priority Data
Sep. 3, 2014 (CN) 201410445098.1

(51) Int. Cl. H04N 21/438; H04N 21/431; H04N 21/845; H04N 21/472

(52) U.S. Cl. CPC H04N 21/4383; H04N 21/47217; H04N 21/431; H04N 21/845

(57) ABSTRACT

An embodiment of the present application discloses a smart terminal as well as a fast channel switching method and device thereof, wherein the method comprises: receiving a media playing request sent by a control device, wherein the media playing request comprises an identification of a channel to be played: starting a first player according to the identification of the channel to be played, wherein the first player is used lot preparing to play the channel to be played, judging whether a second player playing a current playing channel exists; and if the second player that is playing the current playing channel exits, binding a screen display control used by the second player to the first player, and playing the channel to be played through the first player.

### CROSS-REFERENCE TO RELATED APPLICATIONS

This application is a continuation of International Application No. PCT/CN2015/088859, filed on Sep. 2, 2015, which is based upon and claims priority to Chinese Patent Application No. 201410115098.1, filed on Sep. 3, 2014, the entire contents of which are incorporated herein by reference.

### TECHNICAL FIELD

Embodiments of the present application relate to the technical field of media playing and in particular relate to a smart terminal as well as a fast channel switching method and device thereof.

### BACKGROUND

When a media player switches a channel in a video playing process, resources occupied by an old playing instance need to be released before resources are applied and initialized for as new playing instance; lots of time will be consumed in the initialization and release processes of those resources, regardless of memory or other hardware equipment (such as a hardware decoder and so on). In some cases, the time may take up a large proportion, leading to a very bad experience for users.

Taking a media player based on an Android operating system platform as an example, and assuming that there is already a playing instance player1:

MediaPlayer player1=newMediaPlayer( );

player1.setSurface(surface);

player1.start( );

wherein, surface is an instance of a screen display control (Surfaceview), and when it switches to play another network dataflow or media file, player1 needs to be stopped first;

player1.stops( );

player1.release( );

next, an instance player2 is newly created to start playing a new request,

MediaPlayer player2=newMediaPlayer( );

player2.setSurface(surface);

player2.start( ).

In the use of an Android defined API (Application Programming Interface), every playing instance must be provided with one SurfaceView for displaying a video, and otherwise, the video cannot be displayed: further, the life cycle of the SurfaceView is bound to a MediaPlayer, and as long as the MediaPlayer is destroyed, the SurfaceView is also destroyed. In the channel switching process, surface will be destroyed when the playing instance player1 is released and the instance of the SurfaceView needs to be recreated when player2 is created; regardless of the creation process or the destruction process of the SurfaceView, both of the processes need to be processed by adopting a congestive manner which takes a long time due to the related hardware resources involved therein, leading to the channel switching process needing to consume a relatively long time and a very bad use experience had by users.

### SUMMARY

Embodiments of the present application disclose a fast channel switching method and device of a smart terminal to solve the problem where the experience of users is affected due to a long time consumption when a channel is switched for a media player in the prior art.

In order to solve the above problem, the embodiments of the present disclosure disclose a fast channel switching method of a smart terminal. The method includes the following steps: receiving a media playing request that is sent by a control device and includes an identification of a channel to be played; starting, according to the identification of the channel to be played, a first player that is configured to prepare to play the channel to be played; determining whether a second player playing a current playing channel exists; and if the second player that is playing the current playing channel exists, binding a screen display control used by the second player to the first player, and playing the channel to be played by means of the first player.

According to another preferred embodiment of the present disclosure, further disclosed is a smart terminal for fast channel switching. The smart terminal includes at least one processor; and a memory communicably connected with the at least one processor for storing instructions executable by the at least one processor, wherein execution of the instructions by the at least one processor causes the at least one processor to:

receive a media playing request that is sent by a control device and includes an identification of a channel to be played, start, according to the identification of the channel to be played, prepare to play the channel to be played, a player determination module configured to determine whether a second player playing a current playing channel exists, and when the feedback result of the player determination module indicates that the second player is playing the current playing channel, bind a screen display control used by the second player to the first player and play the channel to be played by means of the first player.

According to yet another embodiment of the present disclosure, there is disclosed a non-transitory computer-readable recording medium storing executable instructions that, when executed by an electronic device with a touch-sensitive display, cause the electronic device to:

receive a media playing request sent by a control device, wherein the media playing request comprises an identification of a channel to be played;

start a first player according to the identification of the channel to be played, wherein the first player is used for preparing to play the channel to be played;

judge whether a second player playing a current playing channel exists; and if the second player that is playing the current playing channel exists, bind a screen display control used by the second player to the first player and playing the channel to be played through the first player.

Compared with the prior art, the embodiments of the present application have the following advantages:

in a preferred embodiment of the present application, a mode in which a current playing channel and a new playing channel are enabled to work alternatively is adopted; a screen display control (SurfaceView) is multiplexed in the alternative working process of the playing channels, and therefore, the problem of an overly long time taken due to a need fur congestive release of the SurfaceView in the prior art is solved (as hardware resources such as a decoder and so on need to be released in the release process of the SurfaceView, the congestion release mode needs to be adopted); moreover, the channel switching speed can be effectively increased.

In a further preferred embodiment of the present application, a downloading process, which takes a long time, of data to be played is executed by an independent process in an asynchronous scheduling manner, such that the release of a current playing instance and the preparation work of a new playing instance can be carried out concurrently, and the channel switching speed can be further increased without affecting the operations of a current application layer; hence, the experience of users will be better.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1-1 is a flow diagram of a first embodiment of a fast channel switching method of a smart terminal provided by the embodiments of the present application (an instance is created first and then a SurfaceView is created) .

FIG. 1-2 is a flow diagram of a second embodiment of a fast channel switching method of a smart terminal provided by the embodiments of the present application (a SurfaceView is created first).

FIG. 1-3 is a flow diagram of a third embodiment of a fast channel switching method of a smart terminal provided by the embodiments of the present application (a flow of a stop instance is added).

FIG. 2 is a structural schematic diagram of a first embodiment of a fast Channel switching device of a smart terminal provided by the embodiments of the present application.

FIG. 3 is a sequence diagram of an information transfer process among various modules in an embodiment of a fast channel switching device of a smart terminal provided by the embodiments of the present application.

FIG. 4 shows schematically a block diagram of a smart terminal for executing a method according to the present disclosure.

FIG. 5 shows schematically a storage unit for maintaining or carrying a program code for implementing a method according to the present disclosure.

### DESCRIPTION OF THE EMBODIMENTS

Before further describing the embodiments of the present application in detail in combination with the accompanying drawings and specific embodiments, the working principle of a media player is explained first.

When the media player plays network medias such as network videos and so on, its working principle is: original video data is downloaded through a given network video address, for example, a uniform resource identifier (URI); when the buffer condition is satisfied, data in the buffer area is parsed such that the original audio and video data can be separated, and after the original audio and video data are decoded by the audio and video decodes, respectively, sound and images are output. Taking an Android device as an example, its specific flow is as follows:

MediaPlayer player=newMediaPlayer( ); //a playing instance is initialized;

player.setDataSource(mUri); // a network address is set;

player.setDisplay(mSurfaceHolder); // a display object is set;

player.prepare( ); // a preparation instruction is sent to the player;

player.start( ); // the player sends an instruction of starting playing and actually begins playing after the execution of the fourth step is completed.

### Method Embodiments:

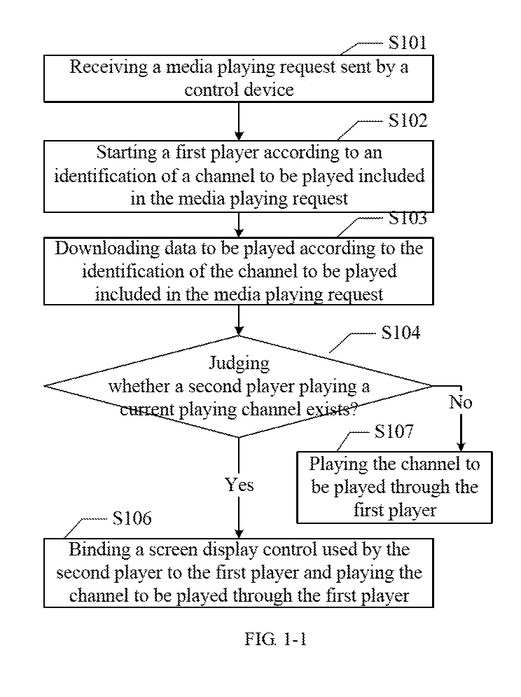

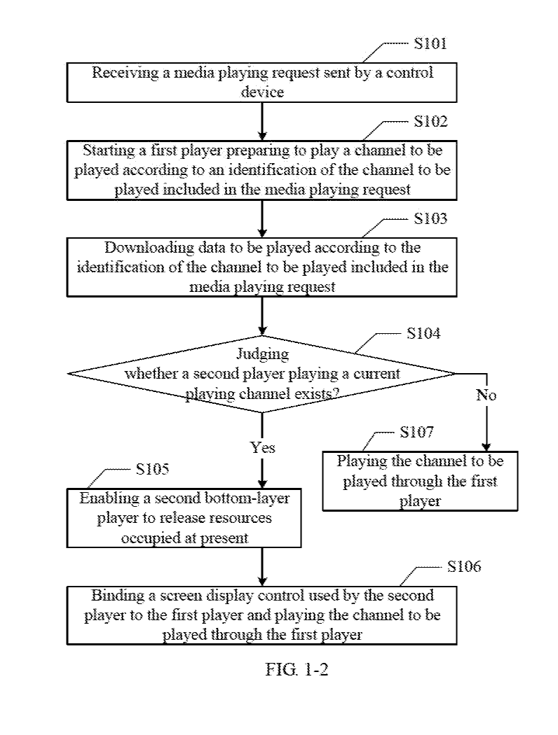

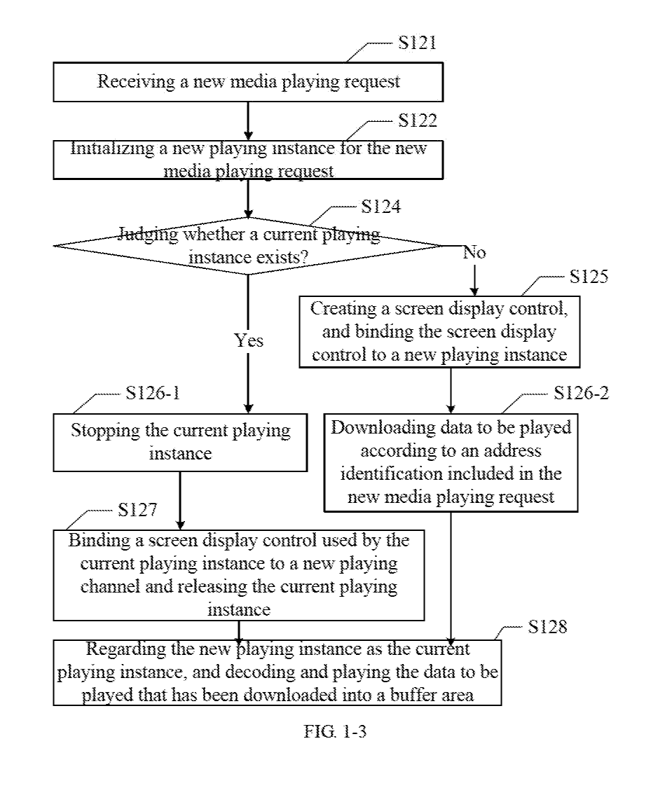

Referring to FIG. 1-1, illustrated is a flow diagram of a first embodiment of a fast channel switching method of a smart terminal provided by the embodiments of the present application; an executive main body is a media player mounted on a terminal, for example, a smart TV or a smart phone. The present preferred method embodiment includes the steps as follows.

Step S101: receiving a media playing request sent by a control device, wherein the media playing request includes an identification of a channel to be played.

Step S102: starting a first player configured to prepare to play the channel to be played according to the identification of the channel to be played included in the media playing request.

Step S103: downloading data of the channel to be played into a buffer area according to the identification of the channel to be played included in the media playing request.

In the present preferred method embodiment, to further increase the channel switching speed and reduce the influence on operations of the current application layer, the downloading process (i.e., step S103), which takes a long time, of the data to be played is executed by an independent process in an asynchronous scheduling manner. Additionally, with regard to the scheduling execution occasion of step S103, step S103 can be scheduled to be executed after step S102 in the above order, or prior to step S107 or step S106.

Step S104: judging whether a second player playing a current playing channel exists; and if so, going to step S106, and otherwise, going to step S107.

Step S106: binding a screen display control used by the second player to the first player and playing the channel to be played through the first player.

Step S107: playing the channel to be played through the first player.

In the present embodiment, through the above means, the screen display control (SurfaceView) can be multiplexed in the alternative working process of a current playing channel and a new playing channel, such that the problem of an overly long time taken due to a need for congestion release of the SurfaceView in the prior art can be effectively avoided (as hardware resources such as a decoder and so on need to be released in the release process of the SurfaceView, the congestion release mode needs to be adopted), and then the channel switching speed can be effectively increased.

In a preferred embodiment of the method embodiments, after the steps S106 and S107 are executed, it may further include:

Step S108: setting the maximum duration and minimum duration parameters of the buffer area

Step S109: comparing a playable time length of data in the buffer area with the parameters, When the playable time length of data in the buffer area is smaller than the minimum duration, enabling the media playing process to pause, and when the playable time length of data in the buffer area is larger than or equal to the maximum duration, enabling the downloading process of the data to be played to pause.

Through the above means, the effect on a user can avoid influence due to frequent appearing of playing pause prompts after the media player starts to play on one hand; on the other hand, the problem of affecting the requests of other applications for network data due to too much network bandwidth being occupied by an overly large cached quantity can also be avoided. In addition, as a policy of setting buffer area parameters after the media begins to play is adopted, the preparation time of step S103 can be shortened as much as possible and the waiting time for channel switching can be further shortened.

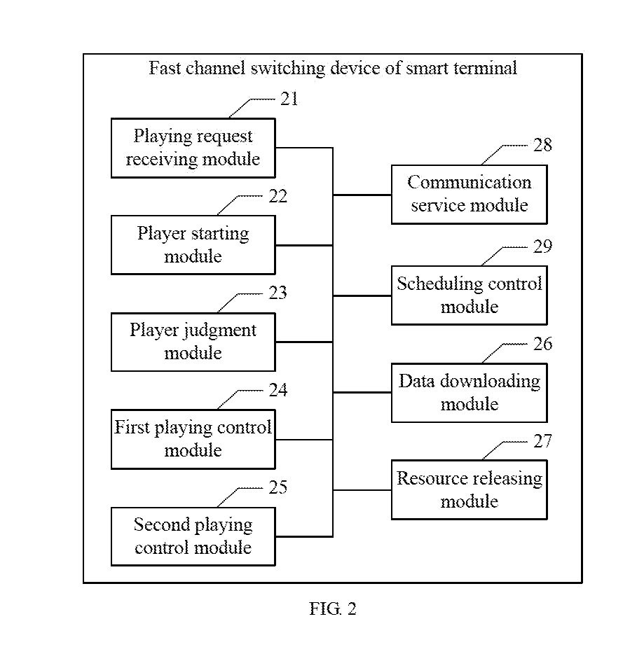

Referring to FIG. 1-2, illustrated is the flow of a second embodiment of a fast channel switching method of a smart terminal provided by the embodiments of the present application; the second method embodiment differs from the first method embodiment in that: the first player may include a first application-layer player and a first bottom-layer player; correspondingly, the second player also may include a second application-layer player and a second bottom-layer player; before executing step S106 (i.e., binding the screen display control used by the second player to the first player and playing the channel to be played through the first player), it further includes step as follows.

Step S105: enabling the second bottom-layer player to release the resources occupied at the present.

Additionally, prior to or at the same time of the execution of the step S105, the second player stops its process of playing the current playing channel, i.e., before the screen display control used by the second player is bound to the first player and the channel to be played is played through the first player, the second player continues to play its current playing channel.

It needs to be noted that step S105 can also be executed after step S101; compared with the above solutions, the present method embodiment has the following advantages: in the starting process of a new player (i.e., the first player) and an asynchronous downloading process of new playing channel data, the original player (i.e., the second player) still continues to execute the media playing process of the original channel, and therefore, black screen time in a channel switching process can be further reduced for a user and the experience of the user can be enhanced.

Referring to FIG. 1-3, illustrated is a flow of a third embodiment of a fast channel switching method of a smart terminal provided by the embodiments of the present application; in this preferred embodiment, descriptions are made by taking a smart terminal installed with an Android system as an example, and a playing channel therein is implemented in the form of a playing instance. The present method embodiment specifically includes steps as follows.

Step S121: receiving a new media playing request.

In the present preferred embodiment, the playing request includes an address identification (e.g., a uniform resource identification URI) of data to be played.

Step S122: initializing a new playing instance for the new media playing request.

For an Android platform, the playing instance can be implemented by adopting the following commands:

MediaPlayer player1=new MediaPlayer ( );

and then the URI of the data to be played is transferred to a downloading scheduling module by using the following command:

Play1.setDataSource (URI).

Step S124: judging whether a current playing instance exists; and if so, going to steps S126-1 and S126-2, and otherwise, going to step S125.

In the present method embodiment, to further increase the channel switching speed and enhance the experience of a user, a downloading process of the data to be played is executed by an independent process in an asynchronous scheduling manner, such that the subsequent release (Step S127) of the current playing instance and the data downloading work (Step S126-2) of the new playing instance can be carried out concurrently.

Step S125: creating a screen display control and binding the newly created screen display control to the new playing instance: and going to step S126-2 for subsequent data downloading and playing flow.

Step S126-1: stopping the current playing instance.

Step S126-2: downloading the data to be played according to the address identification (e.g., URI or URL) included in the new media playing request.

When the data to be played in the buffer area reaches a data volume allowing playing to start and the preset scheduling control information can be fed back, it goes to step S128 to execute the new playing request from the user.

Step S127: binding the screen display control used by the current playing instance to the new playing instance and releasing the current playing instance.

Step S128: regarding the new playing instance as the current playing instance, and decoding and playing the data to be played that has been downloaded into the buffer area.

In another embodiment, regarding a new playing instance as the current playing instance can be realized in a value assignment way. Assuming that the current playing instance is player2 and the new playing instance is player1, the value assignment way could be:

player2=player1.

With regard to the aforementioned various method embodiments, for the sake of simple descriptions, all of them are expressed as a series of motion combinations; however, those skilled in the art should know that the embodiments of the present application are not limited by the described motion order because some steps can be executed in other orders or simultaneously according to the embodiments of the present application; for example, step S109-1 of setting the size of a buffer area can be executed after step S108 or prior to step S103. Moreover, those skilled in the art should also know that the above method embodiments all are preferred embodiments and motions and modules involved therein are not certainly necessary for the embodiments of the present application.

### Device Embodiments:

Referring to FIG. 2, illustrated is a structural block diagram of an embodiment of a fast channel switching device of a smart terminal provided by the embodiments of the present application, including:

a playing request receiving module 21 configured to receive a media playing request sent by a control device, wherein the media playing request includes an identification (e.g., a uniform resource identification) of a channel to be played;

a player starting module 22 configured to start a first player according to the identification of the Channel to be played acquired by the playing request receiving module 21, wherein the first player is used for preparing to play the channel to be played;

a player judgment module 23 configured to judge whether a second player playing a current playing channel exists;

and a first playing control module 24 configured to, when the feedback result of the player judgment module 23 indicates that the second player is playing the current playing channel, bind a screen display control used by the second player to the first player started by the player starting module 22 and play the channel to be played through the first player.

In a further preferred embodiment of the device embodiments, the fast channel switching device further includes:

a second playing control module 25 configured to, when the feedback result of the player judgment module 23 indicates that no second player that is playing the current playing channel exists, play the channel to be played through the first player.

Additionally, the first player includes a first application-layer player and a first bottom-layer player; the second player includes a second application-layer player and a second bottom-layer player; before the first playing control module binds the screen display control used by the second player to the first player and plays the channel to be played through the first player, the second player continues to play the current playing channel. The fast channel switching device of the present preferred embodiment further includes a data downloading module 26 and a resource releasing module 27, wherein:

the data downloading module 26 is configured to schedule the first bottom-layer player to download data of the channel to be played into a buffer area before the first playing control module 24 binds the screen display control used by the second player to the first player and plays the channel to be played through the first player;

and the resource releasing module 27 is configured to release resources occupied by the second bottom-layer player at present before the first playing control module 24 binds the screen display control used by the second player to the first player and plays the channel to be played through the first player.

In this preferred embodiment, to further shorten judgment switching time, the data downloading module 26 is executed by an independent process in an asynchronous scheduling manner, so that the data downloading module 26, the playing request receiving module 21, the first playing control module 24, the second playing control module 25 and the like can be executed concurrently without interfering with each other.

To guarantee that, in an asynchronous working mode, the playing request receiving module 21, the first playing control module 24, the second playing control module 25 and the like can be in effective communication with the data downloading module 26, a communication service module 28 can be further set in this preferred embodiment, and is configured to forward the data downloading instruction sent by the playing request receiving module 21 as well as related feedback information (e.g., state of downloading information, downloading pause, downloading completed and the like of the data downloading module 26) of the data downloading module 26.

In a further preferred embodiment of the device, in order to guarantee effective miming of the media player after starting to play, a scheduling control module 29 is further set, which is configured to set the maximum duration and minimum duration parameters of the buffer area, wherein when a playable time length of data in the buffer area is smaller than the minimum duration parameter, the playing process of the data to be played is enabled to pause; when the playable time length of the data in the buffer area is larger than the maximum duration parameter, the downloading process of the data to be played is enabled to pause.

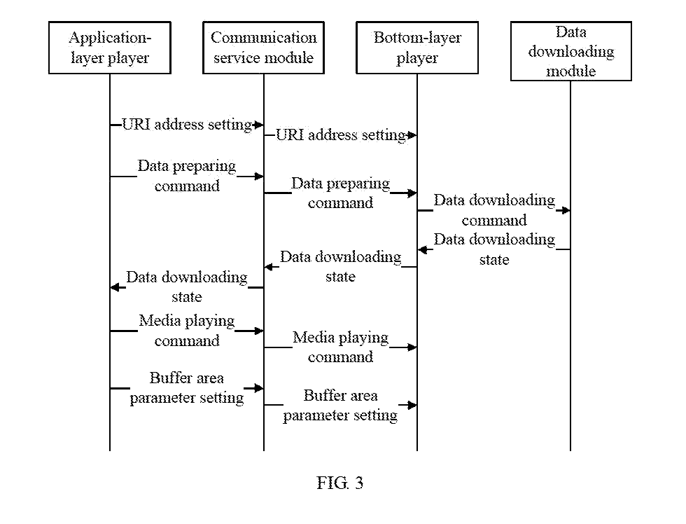

Referring to FIG. 3, illustrated is a sequence diagram of an information transfer process among various modules in an embodiment of a fast channel switching device of a smart terminal provided by the embodiments of the present application, which is specifically described as follows:

firstly, after the playing request receiving module 21 receives a new video playing request, a resource address URI of data to be played is forwarded to a bottom-layer player through the communication service module 28;

secondly, an application-layer player sends an asynchronous data downloading instruction to the bottom-layer player through the communication service module 28, and then the bottom-layer player sends a data downloading request to the data downloading module 26;

thirdly, the data downloading module 26 feeds back the downloading state information to the bottom-layer player, and the bottom-layer player judges whether or not to start playing according to the parameters of the buffer area, and if so, feeds back the state information to the application-layer player through the communication service module 28;

fourthly, the application-layer player sends a video playing instruction to the bottom-layer player through the communication service module 28;

and fifthly, after video playing is started, the application-layer player sends dynamic set parameters of the buffer area to the bottom-layer player through the communication service module 28.

Wherein, the dynamic set parameters of the buffer area includes a minimum buffer area duration (Min-Buffer-Duration) and a maximum buffer area duration (Max-Buffer-Duration); when the time of video data in the buffer area is smaller than the Min-Buffer-Duration, the bottom-layer player will suspend the video playing process until the data downloaded by the data downloading module 26 into the buffer area meets the playing requirement; when the time of video data in the buffer area is larger than or equal to the Max-Buffer-Duration, the data downloading module 26 will suspend the data downloading process, thereby saving network bandwidth for other applications of the device to request network data.

It needs to be noted that, in the above preferred embodiment, the asynchronous data downloading instruction from the application-layer player is forwarded to the bottom-layer player through the communication service module 28, and the data downloading module 26 is scheduled by the bottom-layer player to work and scheduled and processed by an independent process. However, it is not limited in the embodiments of the present application, and other scheduling modes also can be employed; for example, the asynchronous data downloading instruction from the application-layer player can be directly forwarded to the data downloading module 26 through the communication service module 28 for execution, and the execution state information of the data downloading module 26 also can be directly fed back to the application-layer player through the communication service module 28 (in this case, controlling the downloading process according to the parameters of the buffer area is completely by the data downloading module 26 itself).

In the above device embodiments, when the channel to be played is a live broadcast channel, the bottom-layer player can be an instantiated NuPlayer; when the channel to be played is an on-demand channel, the bottom-layer player can be an instantiated StageflightPlayer; the communication service module may judge the type of the channel to be played according to the URI address and select the bottom-layer player.

Additionally, the embodiments of the present application further disclose a smart terminal including the fast channel switching device, such that a channel switching speed can be effectively increased in a video playing process. Wherein, the smart terminal can be a smart TV or a smart phone, which is not limited by the embodiments of the present application and only required to be configured with an Android operating system platform.

It needs to be noted that the device or system embodiments are preferred embodiments, and modules involved therein are not certainly necessary for the embodiments of the present application.

Each embodiment in the description is described in a progressive manner. Descriptions emphasize on the differences of each embodiment from other embodiments, and same or similar parts of various embodiments just refer to each other. For the device embodiments, as they are substantially similar to the method embodiments, the descriptions are relatively simple; for the relevant parts, just see part of descriptions of the method embodiments.

The computer-readable recording medium includes any mechanism for storing or transmitting information in a computer (for example)-readable form. For example, machine-readable mediums include a ready-only memory (ROM), a random access memory (RAM), a magnetic disk storage medium, an optical storage medium, a flash memory medium, signals propagated electrically, optically, acoustically or in other forms (e.g., carriers, infrared signals, digital signals), etc.

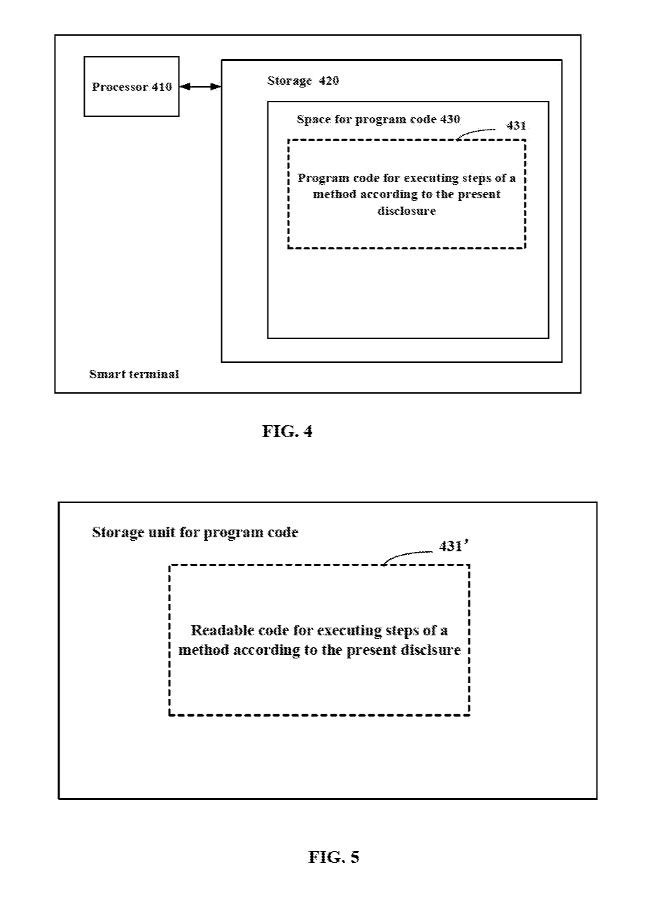

For example, FIG. 4 illustrates a block diagram of a smart terminal for executing the method according the disclosure. Traditionally, the smart terminal includes a processor 410 and a computer program product or a computer readable medium in form of a memory 420. The memory 420 could be electronic memories such as flash memory, EEPROM (Electrically Erasable Programmable Read-Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the server as shown in FIG. 4. The program codes may be compressed for example in an appropriate form, Usually, the memory cell includes computer readable codes 431′ which can be read for example by processors 410. When these codes are operated on the server, the server may execute respective steps in the method as described above.

The smart TV as well as the fast channel switching method and device thereof provided by the embodiments of the present disclosure are introduced above in detail. In this text, specific examples are utilized to elaborate the principle and the embodiments of the present disclosure. The above descriptions of the embodiments are merely intended to help understanding the method of the embodiments of the present disclosure and the core concept thereof. Meanwhile, for a person ordinarily skilled in the art, alterations may be made to the specific embodiments and the application scope according to the concept of the embodiments of the present disclosure. In conclusion, the contents of this description should not be understood as limitations to the embodiments of the present disclosure.

It should be appreciated by a person ordinarily skilled in the art that the implementation of all or part of steps of the above method embodiments may be completed by means of program command related hardware. The above programs may be stored in a computer readable storage medium. When the programs are executed, the steps of the above method embodiments also are executed. Moreover, the above storage medium includes various mediums capable of storing the program codes, such as a ROM, a RAM, a magnetic disk, an optical disk, and the like.

Finally, it should be noted that the various above embodiments are merely used for illustrating, rather than limiting, the technical solutions of the embodiments of the present disclosure. Although the embodiments of the present disclosure are described in detail with reference to the various preceding embodiments, it should be appreciated by a person ordinarily skilled in the art that modifications can still be made to the technical solutions described in the various preceding embodiments, or equivalent substitutions can be made to part of or all technical features therein. The modifications or substitutions do not cause the nature of corresponding technical solutions to depart from the scope of the technical solutions of the various embodiments of the present disclosure.

What is claimed is:

1. A fast channel switching method of a smart terminal, Comprising:
receiving a media playing request sent by a control device, wherein the media playing request comprises an identification of a channel to be played;
starting a first player according to the identification of the channel to be played, wherein the first player is used for preparing to play the channel to be played;
judging whether a second player playing a current playing channel exists;
and if the second player that is playing the current playing channel exists, binding a screen display control used by the second player to the first player and playing the channel to be played through the first player.

2. The fast channel switching method of claim 1, wherein after judging whether the second player playing the current playing channel exists, the method further comprises:
if no second player that is playing the current playing channel exists, playing the channel to be played through the first player.

3. The fast channel switching method of claim 1, wherein the first player comprises a first application-layer player and a first bottom-layer player; the second player comprises a second application-layer player and a second bottom-layer player;
before binding the screen display control used by the second player to the first player and playing the channel to be played through the first player, the method further comprising:
downloading, by the first bottom-layer player, data of the channel to be played into a buffer area;
and releasing, by the second bottom-layer player, resources occupied at present.

4. The fast channel switching method of claim 3, wherein before binding the screen display control used by the second player to the fiat player and playing the channel to be played through the first player, the method further comprises:
continuously playing, by the second player, the current playing channel.

5. The fast channel switching method of claim 1, further comprising:
setting maximum duration and minimum duration parameters of the buffer area;
judging whether a playable time length of data in the buffer area is smaller than the minimum duration parameter, and if so, enabling a playing process of data to be played to pause; and
judging whether the playable time length of the data in the buffer area is larger than the maximum duration parameter, and if so, enabling the downloading process of the data to be played to pause.

6. A smart terminal for fast channel swindling, comprising:
at least one processor; and
a memory communicably connected with the at least one processor for storing instructions executable by the at least one processor, wherein execution of the instructions by the at least one processor causes the at least one processor to:
receive a media playing request sent by a control device, wherein the media playing request comprises an identification of a channel to be played;
start a first player according to the identification of the channel to be played, wherein the first player is used for preparing to play the channel to be played;
judge whether a second player playing a current playing channel exists;
when the feedback result of the player judgment module indicates that the second player is playing the current playing channel, bind a screen display control used by the second player to the first player and play the channel to he played through the first player.

7. The smart terminal of claim 6, wherein execution of the instructions by the at least one processor causes the at least one processor to further:
when the feedback result of the player judgment module indicates that no second player that is playing the current playing channel exists, play the channel to be played through the first player.

8. The smart terminal of claim 6, wherein the first player comprises a first application-layer player and a first bottom-layer player; the second player comprises a second application-layer player and a second bottom-layer player; execution of the instructions by the at least one processor causes the at least one processor to further:
schedule the first bottom-layer player to download data of the channel to be played into a buffer area before the first playing control module binds the screen display control used by the second player to the first player and plays the channel to be played through the first player;
release resources occupied by the second bottom-layer player at present before the first playing control module plays the channel to be played through the first player.

9. The smart terminal of claim 8, wherein the second player continues to play the channel to be played at present before the first playing control module binds the screen display control used by the second player to the first player and plays the channel to be played through the first player.

10. The smart terminal of claim 8, wherein execution of the instructions by the at least one processor causes the at least one processor to further:
set maximum duration and minimum duration parameters of the buffer area and control a data downloading process of a bottom-layer players and a playing process of data to be played of an application-layer player according to the parameters, wherein when a playable time length of data in the buffer area is smaller than the minimum duration parameter, the playing process of the data to be played is enabled to pause; when the playable time length of the data in the buffer area is larger than the maximum duration parameter, the downloading process of the data to be played is enabled to pause.

11. The smart terminal of claim 6, wherein the smart terminal is a smart TV or a smart phone.

12. A non-transitory computer-readable recording medium storing executable instructions that, when executed by an electronic device with a touch-sensitive display, cause the electronic device to:
receive a media playing request sent by a control device, wherein the media playing request comprises an identification of a channel to be played;
start a first player according to the identification of the channel to be played, wherein the first player is used for preparing to play the channel to be played;
judge whether a second player playing a current playing channel exists; and
if the second player that is playing the current playing channel exists, bind a screen display control used by the second player to the first player and playing the channel to be played through the first player.
